(19) United States
(12) Patent Application Publication
(10) Pub. No.: US 2014/0051353 A1
(43) Pub. Date: Feb. 20, 2014

(54) CARD COMMUNICATION DEVICE

(71) Applicant: Yutaka NAKAMURA, Kyoto (JP)

(72) Inventor: Yutaka NAKAMURA, Kyoto (JP)

(73) Assignee: PANASONIC CORPORATION, Osaka (JP)

(21) Appl. No.: 13/759,135

(22) Filed: Feb. 5, 2013

(30) Foreign Application Priority Data
Feb. 6, 2012 (JP) 2012-023081
Feb. 1, 2013 (JP) 2013-018357

(51) Int. Cl. H04B 5/00

(52) U.S. Cl. CPC H04B 5/0031
USPC 455/41.1

(57) ABSTRACT

A card communication device comprises an antenna, a card socket to which a memory card is attached, a detector for detecting whether the memory card is attached to the card socket or not, a switching section for switching electrical connection of a terminal of the antenna to a predetermined connecting terminal of the memory card attached to the card socket between an on state and an off state, and a controller for controlling an operation of the switching section. When the detector detects the attachment of the memory card to the card socket, the controller determines a type of the attached memory card, and only when the determined memory card is a specific type of the memory card, the controller controls the switching section so that the electric connection is switched from the off state into the on state.

### BACKGROUND

1. Technical Field

The present disclose relates to a card communication device for wirelessly communicating with external devices using a memory card having an antenna terminal.

2. Related Art

Terminal structures and interfaces of memory cards used in digital still cameras and mobile telephones are defined according to standards for each type of the memory cards. Memory cards are standardized so as to be capable of being connected with various devices, thereby making wide-range of data passing easy. The standardization of memory cards heightens their general versatility and enables provision at a low price by means of mass production, thereby heightening convenience for users. As a result, memory cards spread rapidly and widely.

Recently, one of the spreading memory cards is a microSD card. Various types of associated standards of microSD cards appear. For example, in addition to conventional microSD cards that only store data in flash memories, NFC microSD cards employing the Near Field Communication standards (hereinafter, “NFC”) that are used for IC cards such as ICOCA card appear.

In the NFC, it is essential that antennas for communication with external devices which readers and writers (hereinafter, “readers, writers etc.”) using electromagnetic coupling are provided. In general, loop antennas that are formed into a loop shape are used in order to electromagnetically-couple efficiently.

The microSD cards have a small size of 11 mm×15 mm. Therefore, even if the microSD cards contain the loop antennas, the size of the antennas is too small to provide practicable outputs. In order to solve this problem, conventionally like JP 2005-269111 A, a method for providing a connecting terminal for an external antenna on a memory card and realizing electromagnetic coupling via the external antenna connected to the connecting terminal so as to secure sufficient outputs is employed.

Electrode terminals for antennas are provided on the NFC microSD cards, and the antenna electrode terminals are connected to external antennas provided on attached various devices and card sockets.

The terminal structures of memory cards are peculiarly defined according to unified standards and types. Therefore, the NFC microSD cards compatible with the Near Field

Communication and the other microSD cards have different terminal structures even in the associated standards of the microSD cards. The arrangements of the electrode terminals are greatly different therebetween.

Certain positions of the NFC microSD cards are provided with antenna electrode terminals. In the other microSD cards (for example, UHS-II microSD cards of high-speed transfer standards), however, terminals for inputting/outputting data are occasionally provided on such positions. Therefore, when the other kinds of microSD cards are attached to card sockets for the NFC microSD cards due to user's mistake, their terminal structures do not match and thus a proper operation is not performed. In addition, occasionally, cards get damaged due to signals applied on attachment.

### SUMMARY

The present disclose is devised in order to solve such a problem, and provides a card communication device that is compatible with a memory card having antenna electrode terminals and does not cause a problem even if another kind of a memory card is attached.

A card communication device of the present disclose includes an antenna; a card socket to which a memory card is attached, a detector for detecting whether the memory card is attached to the card socket, a switching section for switching electrical connection of a terminal of the antenna to a predetermined connecting terminal of the memory card attached to the card socket between an on state and an off state; and a controller for controlling an operation of the switching section. When the detector detects the attachment of the memory card to the card socket, the controller determines a type of the attached memory card, and only when the determined memory card is a specific type of the memory card, the controller controls the switching section so that the electric connection is switched from the off state into the on state.

The card communication device of the present disclose is compatible with memory cards having antenna electrode terminals, and even if other kinds of the memory cards are attached, any problem is not caused and the memory card can be normally operated in most cases.

### BRIEF DESCRIPTION OF DRAWINGS

FIG. 1 is a diagram illustrating a constitution of a wireless card system in accordance with the first embodiment;

FIG. 2 is a flowchart illustrating a process flow after attachment of a memory card;

FIG. 3 is a diagram illustrating a constitution of a card communication device to which a memory card incompatible with wireless communication is attached;

FIG. 4 is a diagram illustrating an example of an internal structure of a switch controller;

FIG. 5 is a diagram illustrating a constitution of a card system having an input/output converter in accordance with the second embodiment;

FIG. 6 is a diagram illustrating a concrete constitution example of an antenna switching box and an input/output converter in accordance with the second embodiment;

FIG. 7 is a diagram illustrating a concrete constitution example of an input/output converter in accordance with the second embodiment;

FIG. 8 is a diagram illustrating a constitution of a card system having an input/output converter in accordance with the third embodiment;

FIG. 9 is a diagram illustrating a concrete constitution example of an antenna switching box and an input/output converter in accordance with the third embodiment;

FIG. 10 is a diagram illustrating a constitution of a card system having an input/output converter in accordance with the fourth embodiment;

FIG. 11 is a diagram illustrating a concrete constitution example of an input/output converter in accordance with the fourth embodiment;

FIG. 12 is a diagram illustrating a constitution of a conventional wireless card system; and

FIG. 13 is a diagram illustrating a constitution of a conventional card communication device to which a memory card incompatible with wireless communication is attached.

### DETAILED DESCRIPTION OF PREFERRED EMBODIMENT

Embodiments will be suitably described in detail below with reference to the drawings. Description that is more detailed than necessary will be occasionally omitted. For example, detailed description about well-known parts and overlapped description about the substantially same constitution will be occasionally omitted. This avoids the following description from being redundant more than necessary and makes understanding of people skilled in the art easy.

The inventors provide the accompanying drawings and the following description for making the people skilled in the art sufficiently understand the present disclose, and they are not intended to limit the main subject described in the scope of claims.

(First Embodiment)

A card communication device according to the first embodiment will be described below with reference to the drawings.

<Conventional Card Communication Device>

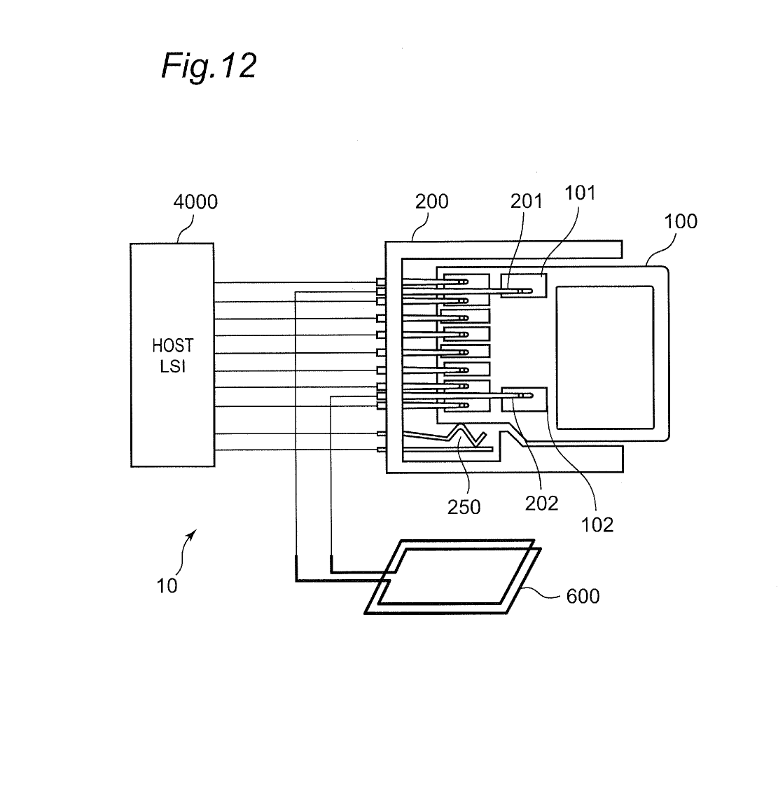

FIG. 12 illustrates a constitution of a conventional card communication device 10 to which an NFC microSD card 100 is attached. In the drawing, both the NFC microSD card 100 and the card communication device 10 compose a wireless card system. As shown in FIG. 12, the card communication device 10 includes a socket 200 for the NFC microSD card, a memory card detecting mechanism 250, a loop antenna 600, and a host LSI 4000.

As shown in FIG. 12, electrode terminals are arranged on a surface of the NFC microSD card 100 into two columns where a vertical direction in the drawing is a column direction. Input/output electrode terminals that are common in the associated standards of conventional microSD cards are provided on the first column positioned on a card end side. Antenna electrode terminals 101 and 102 for connection with the loop antenna 600 are provided on the second column positioned on a card center side. One of the terminals provided on the first column is a ground terminal which connected to ground.

The socket 200 for the NFC microSD card has antenna contact pins 201 and 202 to be electrically connected with the antenna electrode terminals 101 and 102 of the NFC microSD card 100. The antenna contact pins 201 and 202 are connected with both terminals of the loop antenna 600. All the electrode terminals (the electrode terminals on the first column) other than the antenna electrode terminals 101 and 102 are connected to the host LSI 4000 via the contact pins.

The memory card detecting mechanism 250 determines whether a memory card including the NFC microSD card 100 is attached to the socket 200 for the NFC microSD card based on conduction/non-conduction between two terminals. Such a memory card detecting mechanism 250 is widely used in the socket for the commercially available memory card.

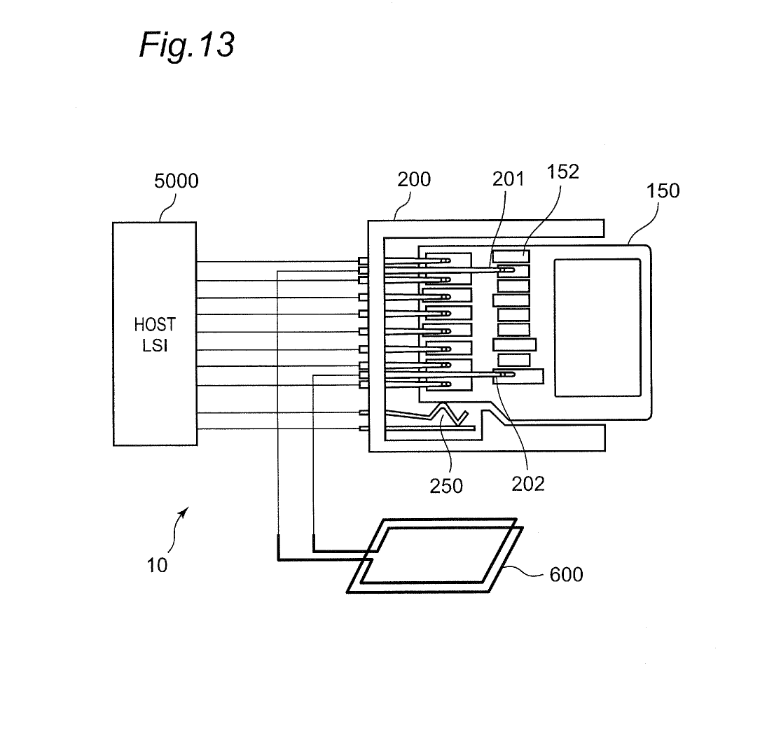

FIG. 13 is a diagram illustrating a state that a UHS-II microSD card 150 is mistakenly attached to the socket 200 for the NFC microSD card in the card communication device 10. The UHS-II microSD card 150 is a high transfer speed card standard that is developed by heightening a bus clock and a timing speed of a conventional microSD card.

In the UHS-II microSD card 150, in order to heighten the speed of an interface, a plurality of high-speed signal-exclusive terminals 152 are provided at positions on the second column overlapped with the provided positions of the antenna electrode terminals 101 and 102 in the NFC microSD card 100.

Therefore, when the user mistakenly attaches the UHS-II microSD card 150 to the socket 200 for the NFC microSD card of the card communication device 10, as shown in FIG. 13, the antenna contact pins 201 and 202 contact with the high-speed signal-exclusive terminal 152 of the UHS-II microSD card 150. Since the antenna contact pins 201 and 202 are connected to both terminals of the loop antenna 600, the loop antenna 600 contacts with the high-speed signal-exclusive terminal 152 of the UHS-II microSD card 150.

When the loop antenna 600 send and receives signals using electromagnetic couples, a voltage (for example, 15 V) that is ten times as high as a voltage to be normally applied to the high-speed signal-exclusive terminal 152 is generated between both the terminals

Therefore, as shown in FIG. 13, when the antenna contact pins 201 and 202 contact with the high-speed signal-exclusive terminal 152 of the UHS-II microSD card 150, a voltage that exceeds an allowable withstand voltage is applied from the loop antenna 600 to the high-speed signal-exclusive terminal 152. As a result, a high-speed interface circuit element inside a card to be connected to the high-speed signal-exclusive terminal 152 is damaged.

In order to avoid such a damage of the high-speed interface circuit element inside the card to be connected to the high-speed signal-exclusive terminal 152, the following countermeasure is considered. With the countermeasure, the loop antenna 600 is designed into a shape and a size such that a voltage to be applied from the loop antenna 600 is reduced.

However, the NFC microSD card 100 converts the voltage supplied from the loop antenna 600 through the antenna contact pins 201 and 202 into a card driving power inside the card. Therefore, in order that the NFC microSD card 100 to be attached obtains sufficient driving power, the voltage to be applied from the loop antenna 600 cannot be carelessly dropped.

Additionally, readers, writers etc., which are connected to the NFC microSD card and become partners of electromagnetic couples, are generally standardized so as to be able to communicate with other devices than the NFC microSD card. Thereby, reducing the strength of electromagnetic couples for the NFC microSD card is unrealistic since that might cause damage to communications with other devices.

On the other hand, in order to prevent the damage of the high-speed interface circuit element in the card connected to the high-speed signal-exclusive terminal 152, a countermeasure that heightens the allowable withstand voltage of the high-speed signal-exclusive terminal 152 is considered.

However, the high-speed signal-exclusive terminal 152 of the UHS-II microSD card 150 is formed by an electrostatic capacity that is not more than ⅓ of a signal terminal of a conventional SD card so that a signal with small amplitude can be exchanged at a high speed. Further, the high-speed signal-exclusive terminal 152 is connected to the high-speed interface circuit element formed by a fine semiconductor process. As a result, the allowable withstand voltage of the high-speed signal-exclusive terminal 152 drops to about ⅓ of the allowable withstand voltage of the connecting terminal of the conventional microSD card. The voltage is, for example, as less as about 1.5 V.

In order to heighten the small allowable withstand voltage of the high-speed signal-exclusive terminal 152, a method for providing a protective element to the high-speed signal-exclusive terminal 152 is considered. However, the electrostatic capacity of the high-speed signal-exclusive terminal 152 should be repressed to not more than ⅓ of the electrostatic capacity at the signal terminal of the conventional SD card. Therefore, the protective element with sufficient capacity cannot be provided, and thus it is difficult to heighten the allowable withstand voltage using the protective element.

As a result of earnest studies, the inventors of the present application uniquely find out that when the UHS-II microSD card 150 is attached to the conventional card communication device 10 due to user's mistake, a serious problem of the damage of a memory card due to an antenna voltage is caused.

<Constitution of the Card Communication Device>

The card communication device according to the first embodiment is compatible with the NFC microSD card 100, and even if the UHS-II microSD card 150 is attached to a card socket due to user's mistake, the damage of the memory card due to an antenna voltage is not caused.

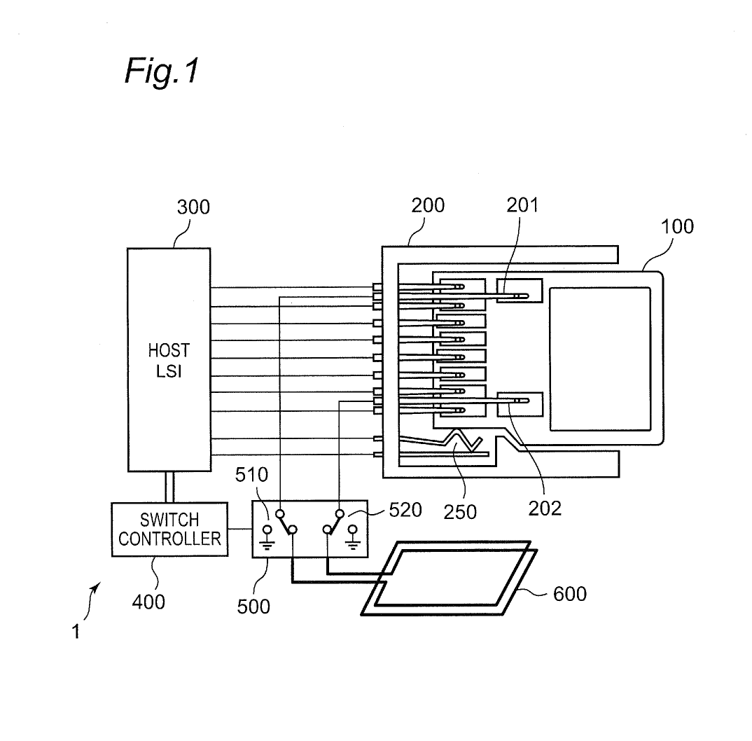

FIG. 1 illustrates a constitution of the wireless card system including a card communication device 1 according to the first embodiment. The wireless card system is composed of the card communication device 1 and the NFC microSD card 100 that is attached to the card communication device 1. In the card communication device 1, the same members as those of the conventional card communication device 10 are denoted by the same reference symbols and the description thereof is omitted.

As shown in FIG. 1, the card communication device 1 includes a host LSI 300, a switch controller 400, and an antenna switching box 500.

The host LSI 300 is composed of, for example, a large-scale integrated circuit, and controls the entire operation of the card communication device 1. The host LSI 300 issues an order to the NFC microSD card 100 attached to the socket 200 for the NFC microSD card, and exchanges various signals with the NFC microSD card 100.

The switch controller 400 is a circuit for driving the antenna switching box 500 based on the order from the host LSI 300, and controlling operations of switches 510 and 520 inside the antenna switching box 500.

The antenna switching box 500 is provided between the antenna contact pins 201 and 202 and the loop antenna 600. The antenna switching box 500 contains the switches 510 and 520 for switching electric connection of the antenna contact pins 201 and 202 between a state of connection to the loop antenna 600 and a grounded state. The switches 510 and 520 operate based on a signal from the switch controller 400.

<Process at Time of Attaching Card>

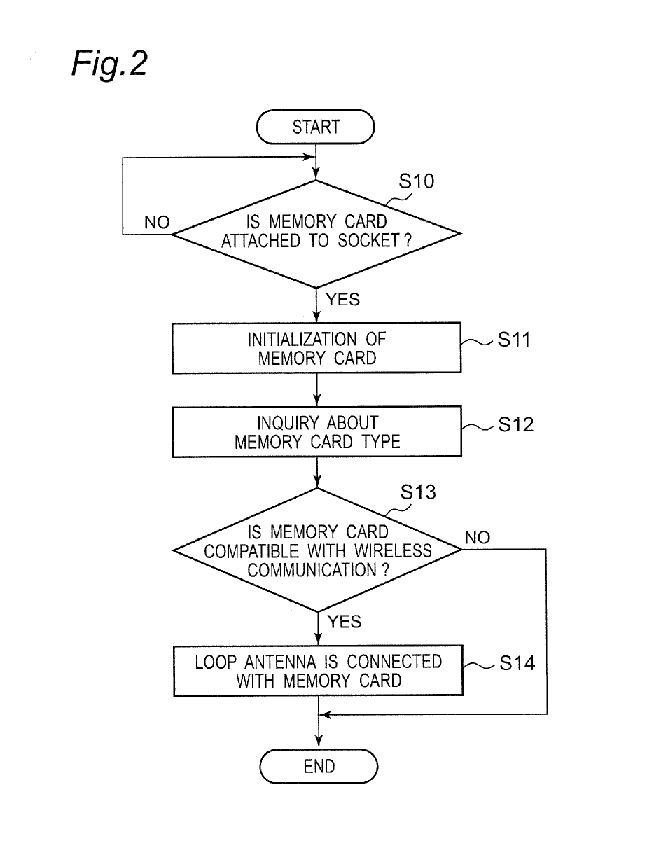

A control flow of the host LSI 300 at a time when the memory card is attached to the socket 200 for the NFC microSD card is described with reference to a flowchart of FIG. 2. In an initial state of where the memory card is not attached to the socket 200 for the NFC microSD card in the card communication device according to the first embodiment, the switches 510 and 520 are controlled so that the antenna contact pins 201 and 202 are grounded.

When any memory card is attached to the socket 200 for the NFC microSD card, the host LSI 300 detects attachment of the memory card via conduction of the memory card detecting mechanism 250 (S10).

When the host LSI300 detects the attachment of the memory card to the socket 200 for the NFC microSD card, the host LSI 300 initializes the memory card (S11). That is to say, the host LSI 300 issues an initializing order to the memory card attached to the socket 200 for the NFC microSD card, and executes an initializing process on the memory card attached to the socket 200 for the NFC microSD card. This initializing process is executed through a terminal common between conventional microSD cards on the first column positioned on the card end side.

The host LSI 300 inquires at the memory card attached to the socket 200 for the NFC microSD card about its type (S12). Concretely, the host LSI 300 issues a command for inquiring at the memory card attached to the socket 200 for the NFC microSD card about the type of the memory card. The memory card that receives this command gives the host LSI 300 a reply about self card type (the UHS-II microSD card as the NFC microSD card) according to recording contents of an internal register.

The host LSI 300 determines whether the memory card attached to the socket 200 for the NFC microSD card is the memory card (the NFC microSD card 100) compatible with wireless communication to be connected to the loop antenna 600 according to the reply from the memory card (S13).

As a result of the determination at step S13, when the memory card attached to the socket 200 for the NFC microSD card is the NFC microSD card 100 compatible with wireless communication, the host LSI 300 connects the loop antenna 600 with the NFC microSD card (S14). Concretely, the host LSI 300 sends an order to the switch controller 400 and electrically connects the antenna contact pins 201 and 202 with both terminals of the loop antenna 600 via the operations of the switches 510 and 520 so as to complete a series of the process.

On the other hand, as the result of the determination at step S13, when the memory card attached to the socket 200 for the NFC microSD card is not the NFC microSD card 100 compatible with wireless communication, the host TSI 300 does nothing and ends the process.

With the above process, when the memory card is not attached to the socket 200 for the NFC microSD card or the memory card attached to the socket 200 for the NFC microSD card is not the NFC microSD card 100 compatible with wireless communication, the antenna contact pins 201 and 202 are not connected with the loop antenna 600 in the card communication device 1. In these cases, the antenna contact pins 201 and 202 are grounded.

When removal of the memory card from the socket 200 for the NFC microSD card is detected based on an output from the memory card detecting mechanism 250, the host LSI 300 transmits a command to the switch controller 400. With this command, the switches 510 and 520 operate and electrically separate the antenna contact pins 201 and 202 from both terminals of the loop antenna 600 so as to ground them.

<Case where Improper Memory Card is Attached>

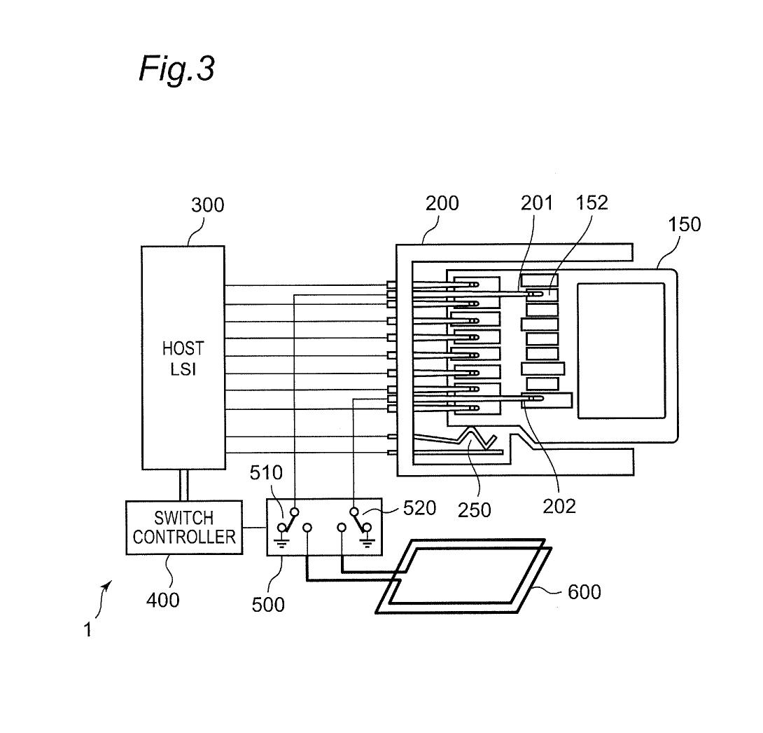

FIG. 3 is a diagram illustrating a state that the UHS-II microSD card 150 is attached to the socket 200 for the NFC microSD card of the card communication device 1 due to user's mistake. When such improper attachment is carried out, the determination is made at process step S13 after the attachment of the memory card that the attached memory card is not the NFC microSD card 100 compatible with wireless communication (No at step S13).

For this reason, the antenna contact pins 201 and 202 are not connected with the loop antenna 600 and are still grounded. As a result, the high-speed signal-exclusive terminal 152 of the UHS-II microSD card 150 attached to the socket 200 for the NFC microSD card is not connected to the loop antenna 600. As a result, the high-speed interface circuit element inside the card to be connected to the high-speed signal-exclusive terminal 152 is not damaged by an applied voltage from the loop antenna 600.

When the UHS-II microSD card 150 is attached to the socket 200 for the NFC microSD card, the UHS-II microSD card 150 is not connected to the loop antenna 600, but the terminals on the first column positioned at the card end side (see FIG. 3) are connected normally to the host LSI 300. As a result, the UHS-II microSD card 150 cannot transmit signals at a high speed but can realize a function as a normal conventional microSD card.

<Constitutional Example of the Switch Controller>

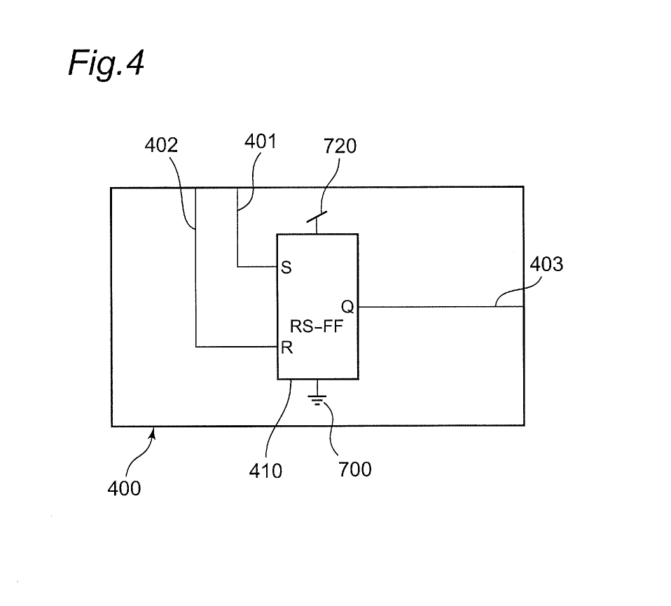

FIG. 4 is a diagram illustrating an example of an internal constitution of the switch controller 400. In this example, the switch controller 400 is constituted by using RS flip flop 410. The RS flip-flop 410 accepts a set signal and a reset signal from the host LSI 300.

Concretely, in the card communication device 1, when the NFC microSD card 100 is attached to the socket 200 for the NFC microSD card, a check is made at step S13 in the process flow after the attachment of the memory card that the memory card attached to the socket 200 for the NFC microSD card is the NFC microSD card compatible with wireless communication. As a result, the host LSI 300 outputs a set signal to the RS flip-flop 410 at step S14 via a set signal line 401. As a result, the RS flip-flop 410 is set.

On the other hand, the host LSI 300 detects that the memory card is removed from the socket 200 for the NFC microSD card or the memory card is not currently attached to the socket 200 for the NFC microSD card based on the conductive state of the memory card detecting mechanism 250. When these are detected, the host LSI 300 outputs a reset signal to the RS flip-flop 410 via a reset signal line 402. As a result, the RS flip-flop 410 is reset.

The antenna switching box 500 detects the state of the RS flip-flop 410 via switch control line 403. The antenna switching box 500 switches the signal line to be connected to the antenna contact pins 201 and 202 according to the detected state of the RS flip-flop 410. Concretely, when the RS flip-flop 410 is in the set state, the antenna switching box 500 connects the signal line led to the antenna contact pins 201 and 202 with the loop antenna 600. On the other hand, when the RS flip-flop 410 is in the reset state, the antenna switching box 500 grounds the signal line led to the antenna contact pins 201 and 202.

<Operation at OFF Time of Main Power Supply>

In the card communication device 1, a standby power supply, which, even when the main power supply of the card communication device 1 is brought into the off state, always supplies a power to the memory card detecting mechanism 250, the host LSI 300, the switch controller 400 and the antenna switching box 500, may be provided. When a standby power supply is provided, even if the main power supply of the card communication device 1 is in the off state, the LSI 300 can execute the above various processes.

For example, even when the main power supply of the card communication device 1 is in the off state, the RS flip-flop 410 receives a power supply from a standby power supply 720 (the standby power supply). For this reason, even if the main power supply of the card communication device 1 is in the off state, the RS flip-flop 410 can retain the set state or the reset state. As a result, also a route of the signal line led to the antenna contact pins 201 and 202 is maintained regardless of the on/off state of the main power supply of the card communication device 1.

Further, also particularly the circuit that receives a detected signal from the memory card detecting mechanism 250 in the host LSI 300 may receive the power supply from the standby power supply 720.

As a result, even in a case where the main power supply of the card communication device 1 is off, namely, in the standby state, when the memory card is removed from the socket 200 for the NFC microSD card, the removal can be detected by a part of the host LSI 300. When the host LSI 300 detects that the memory card is removed from the socket 200 for the NFC microSD card, it gives the reset signal to the RS flip-flop 410.

On the contrary, when the main power supply of the card communication device 1 is off, namely, in the standby state, if a memory card is newly attached to the socket 200 for the NFC microSD card, a part of the host LSI 300 that receives a signal from the memory card detecting mechanism 250 can detect the attachment of the memory card. In this case, the host LSI 300 controls the main power supply of the card communication device 1, and may switch the main power supply from the off state into the on state.

When the main power supply of the card communication device 1 is switched into the on state, the host LSI 300 determines a type of the memory card attached to the socket 200 for the NFC microSD card according to the process after the attachment of the memory card (see the step S13). When the determination is made that the memory card attached to the socket 200 for the NFC microSD card is the NFC microSD card 100 compatible with wireless communication, the host LSI 300 transmits a command to the switch controller 400. This command controls the antenna switching box 500 via the switch controller 400. As a result, the switches 510 and 520 operate so as to connect the antenna contact pins 201 and 202 to the loop antenna 600.

Even in a case where the main power supply of the card communication device 1 is off, namely, in the standby state, when the NFC microSD card 100 is attached to the socket 200 for the NFC microSD card, the NFC microSD card 100 is connected to the loop antenna 600. As a result, the NFC microSD card 100 can realize a function for wirelessly communicating with external devices via the loop antenna 600 while being supplied with a power from the loop antenna 600.

After the NFC microSD card 100 attached to the socket 200 for the NFC microSD card is connected to the loop antenna 600, the host LSI 300 may automatically bring the main power supply of the card communication device 1 into the off state. In this case, even when the main power supply of the card communication device 1 is automatically brought into the off state, the NFC microSD card 100 attached to the socket 200 for the NFC microSD card maintains the state of the connection with the loop antenna 600. As a result, while the main power supply of the card communication device 1 is in the OFF state to save the power, the wireless communication between the NFC microSD card 100 and external devices can be realized or maintained.

(Second Embodiment)

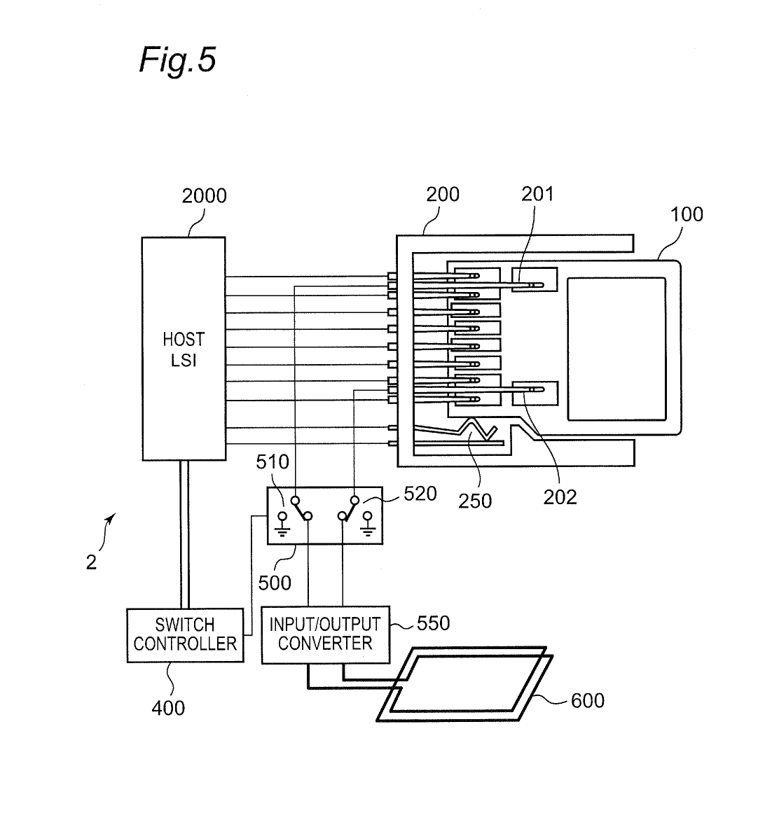

A card communication device 2 according to another embodiment will be described below with reference to FIG. 5. Parts in the constitution of the card communication device 2 that are the same as that in the constitution of the card communication device 1 will be denoted by the same reference symbols, and the description thereof is omitted.

As shown in FIG. 5, in addition to the constitution of the first embodiment, the card communication device 2 according to the present embodiment, has an input/output converter 550 between the antenna switching box 500 and the loop antenna 600. The input/output converter 550 is composed of a microcomputer chip, and the like. The input/output converter 550 transmits/receives wireless signals via the loop antenna 600.

Concretely, the input/output converter 550 converts an analog electromagnetic induction signal received via the loop antenna 600 into a predetermined digital signal, and outputs this digital signal to the antenna contact pins 201 and 202. For example, the input/output converter 550 can employ SWP (Single Wire Protocol) as a protocol for inputting/outputting into/from the antenna contact pins 201 and 202 and exchanging digital signals with the NFC microSD card 100.

When analog signals received by the loop antenna 600 are converted into the signal specification that is compatible with SWP, SWIO signals and a power supply for NFC are provided. To the antenna contact pin 201 a power supply for NFC is provided from the input/output converter 550 via the antenna switching box 500. To the antenna contact pin 202 SWIO signals are provided from the input/output converter 550 via the antenna switching box 500.

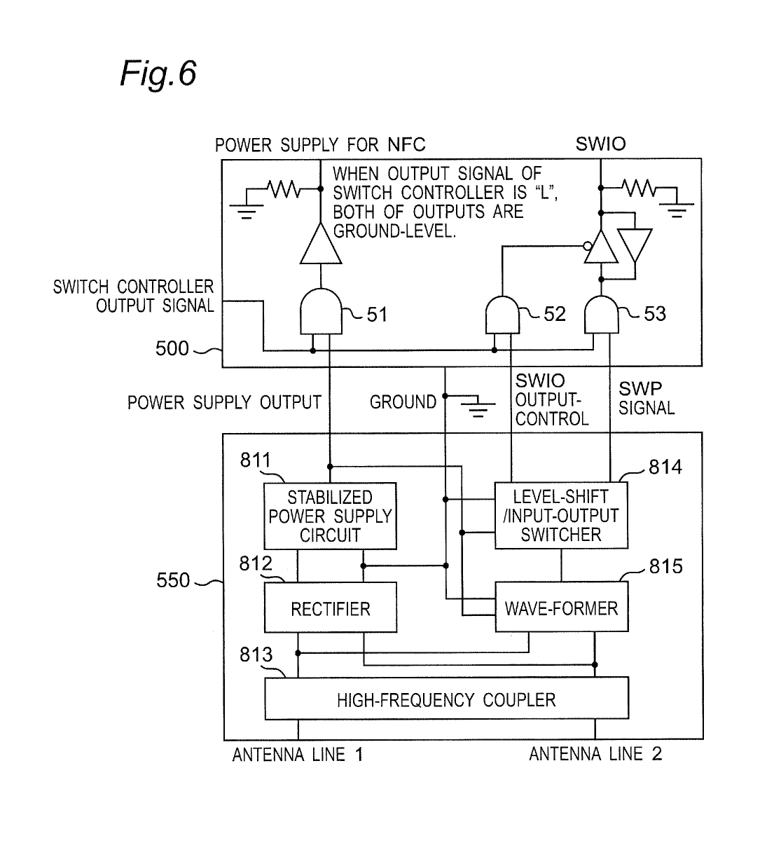

FIG. 6 illustrates a detailed constitution of the antenna switching box 500 and the input/output converter 550. The antenna switching box 500 includes AND gates 51, 52 and 53. Based on output signal from these AND gates 51, 52, 53 and the switch controller 400, the transmission/interruption of the power supply for NFC and the SWIO signals from the input/output converter 550 to the NFC microSD card 100 is controlled.

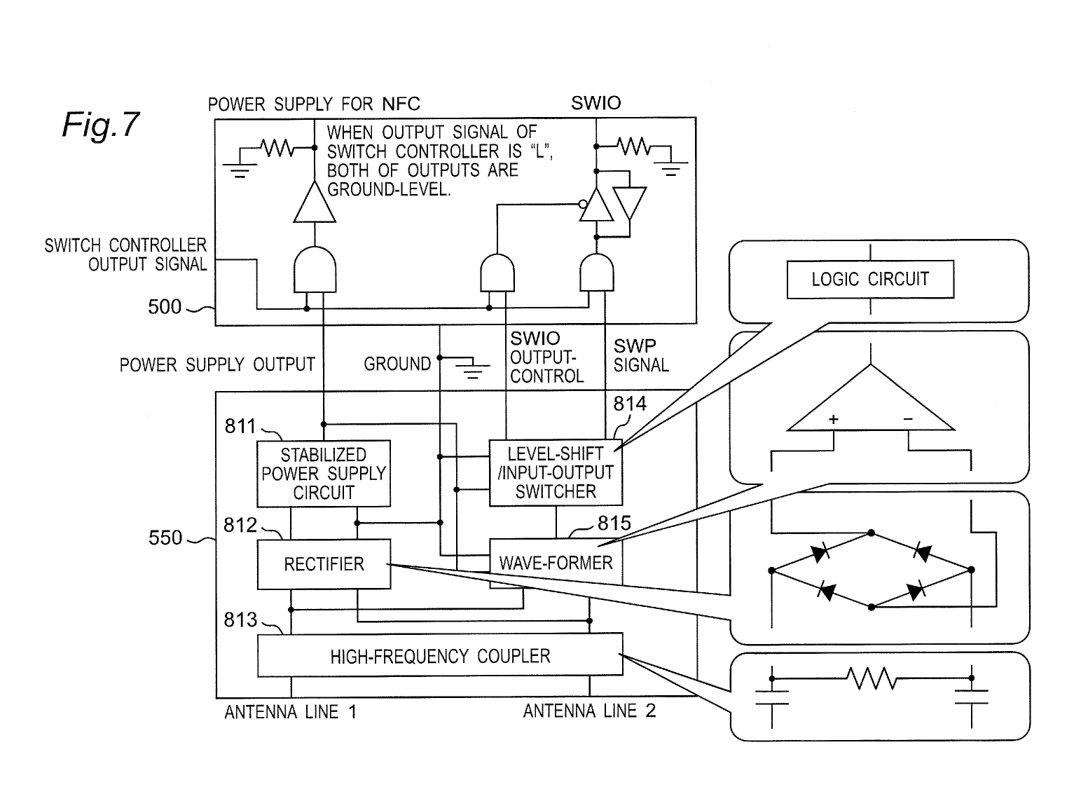

The input/output converter 550 includes a stabilized power supply circuit 811, a rectifier 812, a high-frequency coupler 813, a level-shift/input-output switcher 814 and a wave-former 815. FIG. 7 is a diagram illustrating a concrete constitution example of each of circuits in the input/output converter. A high-frequency coupler 813 is, for example, composed of resistance(s) and capacitor(s). A rectifier 812 includes a full-wave rectifying bridge composed of diodes. A wave-former 815 is composed of comparator(s). A level-shift/input-output switcher 814 is composed of logic circuit(s).

Signals (AC signals) received by the loop antenna 600 are input via the high-frequency coupler 813 to the rectifier 812, and therein are rectified to be converted to DC voltages. The stabilized power supply circuit 811 converts the DC voltages from the rectifier 812 to the predefined voltages to output as power supply for NFC. The output voltages from the stabilized power supply circuit 811 are also provided to the wave-former 815 and to the level-shift/input-output switcher 814.

Additionally, signals (AC signals) received by the loop antenna 600 are input via the high-frequency coupler 813 to the wave-former 815. The wave-former 815 converts signals received from the high-frequency coupler 813 into binary signals. The level-shift/input-output switcher 814 converts the levels of the binary signals received from the wave-former 815 to the predefined levels to output as SWP signals.

Additionally, the level-shift/input-output switcher 814 outputs SWIO output control signals to control the transmission direction of signals between the loop antenna 600 and the NFC microSD card 100. The antenna switching box 500, in accordance with the SWIO output control signals, switches between one internal circuit for sending operation of signals to the loop antenna 600 and the other internal circuit for receiving operation of signals from the loop antenna 600.

For convenience of explanation, FIG. 6 shows, concerning the antenna switching box 500 and the input/output converter 550, mainly a constitution for transmitting signals received by the loop antenna 600 to the NFC microSD card 100 (that is, a constitution for the receiving operation). FIG. 6 omits, for convenience of explanation, a constitution for sending signals from the NFC microSD card 100 to the loop antenna 600 (that is, a constitution for the sending operation) (this shall apply to the below embodiments).

The operation of the antenna switching box 500 is controlled by the output signals from the switch controller 400. Concretely, when the output signal from the switch controller 400 is “high”, power supply for NFC and SWP signal output from the input/output converter 550 are transmitted to the NFC microSD card 100. On the other hand, when the output signal from the switch controller 400 is “low”, the signal lines of power supply for NFC and SWP signal are connected to the ground potential. As a result, the NFC microSD card 100 is isolated of the loop antenna 600.

In accordance with the above constitution, switches of the antenna switching box 500 can be composed of not analog switches but digital switches. As a result, downsizing the circuit constitution can be realized. In addition, power for driving can be generated from the signals received using electromagnetic coupling at the loop antenna 600. Therefore, regardless of presence or absence of SD card and the type of SD card, when signals are received using electromagnetic coupling at the loop antenna 600, the input/output converter 550 will operate.

Further, when the input/output converter 550 employs SWP as the protocol for exchanging digital signals with the NFC microSD card 100, the NFC microSD card 100 easily communicates with readers, writers etc. according to SWP. In this case, the constitution of the input/output converter 550 can be comparatively simplified. The input/output converter 550 that is compatible with SWP is available in the market as a SWIO chip.

The protocol for converting the analog electromagnetic coupling signal received via the loop antenna 600 into a predetermined digital signal using the input/output converter 550 is not limited to SWP, and may employ any protocol.

At the same time, the input/output converter 550 has a power feeding function for supplying a comparatively high rated voltage of, for example, 1.8 V or 3 V to the antenna contact pins 201 and 202 based on the electromagnetic induction signals received via the loop antenna 600. That is to say, the input/output converter 550 can serve as a level converter for adjusting a voltage of the electromotive force by electromagnetic induction output from the loop antenna 600.

Also in the card communication device 2, similarly to the card communication device 1, the voltage (for example, 1.8 V or 3 V) supplied by the input/output converter 550 exceeds about 1.5 V as the allowable withstand voltage of the high-speed signal-exclusive terminal 152 in the UHS-II microSD card 150.

Therefore, similarly to the card communication device 1, when not the NFC microSD card 100 but the UHS-II microSD card 150 is attached to the socket 200 for the NFC microSD card of the card communication device 2 due to user's mistake, the high-speed interface circuit element inside the UHS-II microSD card 150 to be connected to the high-speed signal-exclusive terminal 152 might be damaged due to the feeding function of the input/output converter 550.

After a memory card is attached to the socket 200 for the NFC microSD card, the host LSI 300 of the card communication device 2 executes the process flow that is the same as that of the host LSI 300 of the card communication device 1 (see FIG. 2).

As a result, also in the card communication device 2, when a memory card is not attached to the socket 200 for the NFC microSD card or the attached memory card is not the NFC microSD card 100 compatible with wireless communication, the antenna contact pins 201 and 202 are not connected to the loop antenna 600. That is to say, in these cases, the antenna contact pins 201 and 202 are grounded.

As a result, also in the card communication device 2, due to high-voltage feeding from the input/output converter 550, the UHS-II microSD card 150 that is attached mistakenly can be avoided from being damaged.

(Third Embodiment)

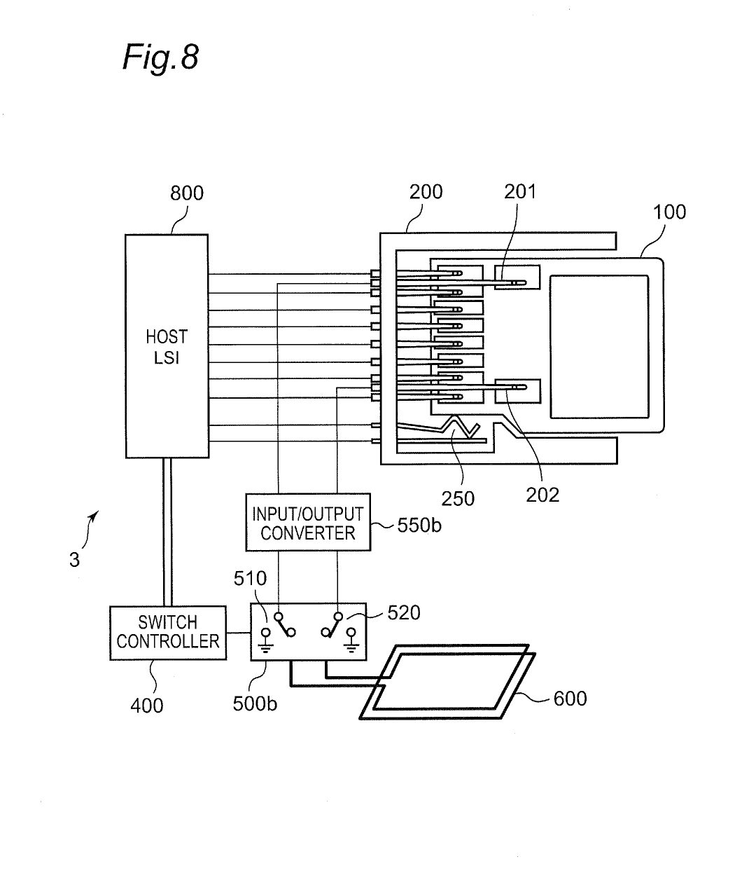

A card communication device 3 according to yet another embodiment will be described below with reference to FIG. 8. Parts in the constitution of the card communication device 3 that are the same as that in the constitution of the card communication device 1 will be denoted by the same reference symbols, and the description thereof is omitted.

As shown in FIG. 8, in addition to the constitution of the first embodiment, the card communication device 3 according to the present embodiment has an input/output converter 550b between the antenna contact pins 201, 202 and the antenna switching box 500b.

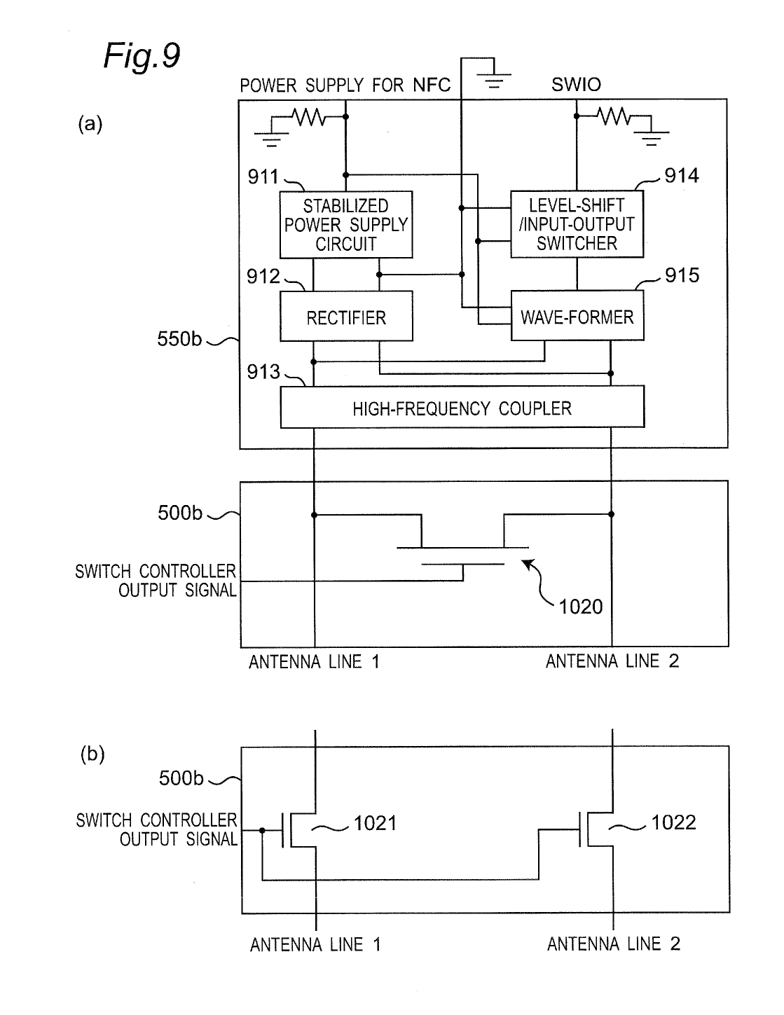

FIG. 9(a) illustrates a detailed constitution of the antenna switching box 500b and the input/output converter 550b. The input/output converter 550b includes a stabilized power supply circuit 911, a rectifier 912, a high-frequency coupler 913, a level-shift/input-output switcher 914 and a wave-former 915. These circuits are basically same as those explained in the second embodiment.

The antenna switching box 500b has, as switches 510 and 520, a transistor 1020 capable of shorting between the antenna lines of the loop antenna 600. The on/off of the transistor 1020 is controlled based on the output signal of the switch controller 400. By switching the transistor 1020 on and shorting between the antenna lines, the NFC microSD card 100 can be isolated of the loop antenna 600.

FIG. 9(b) illustrates another constitution example of the antenna switching box 500b. In this example, each of the antenna lines of the loop antenna 600 has, as switches 510 and 520, a transistor 1021 and 1022. By switching the transistors 1021 and 1022 off based on the output signal of the switch controller 400, the NFC microSD card 100 can be isolated of the loop antenna 600.

(Fourth Embodiment)

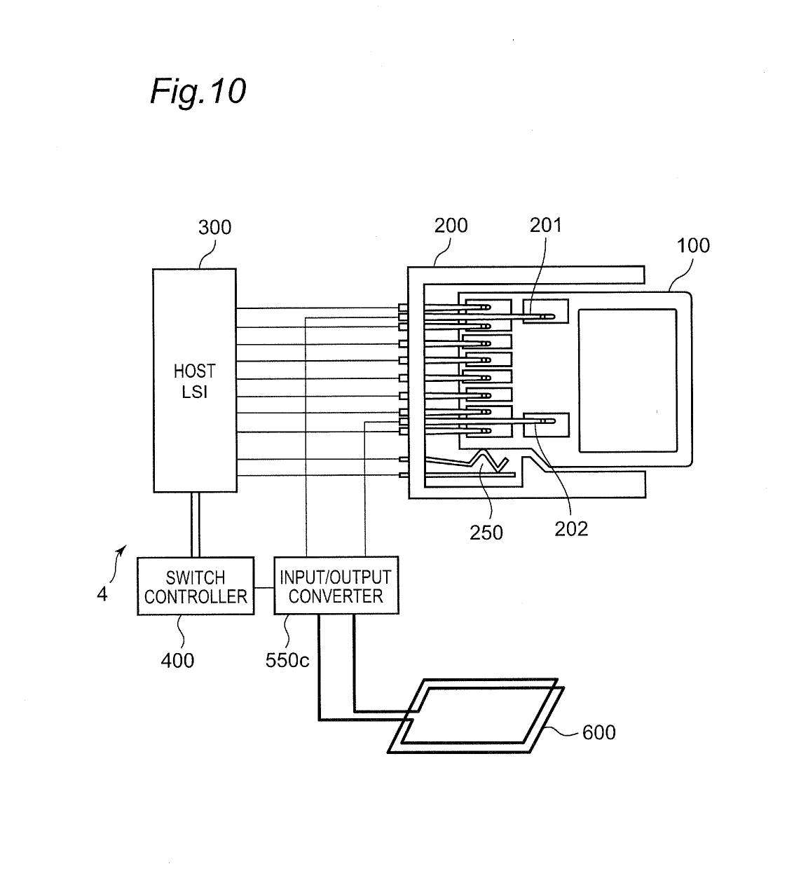

A card communication device 4 according to yet another embodiment will be described below with reference to FIG. 10. Parts in the constitution of the card communication device 4 that are the same as that in the constitution of the card communication device 1 will be denoted by the same reference symbols, and the description thereof is omitted.

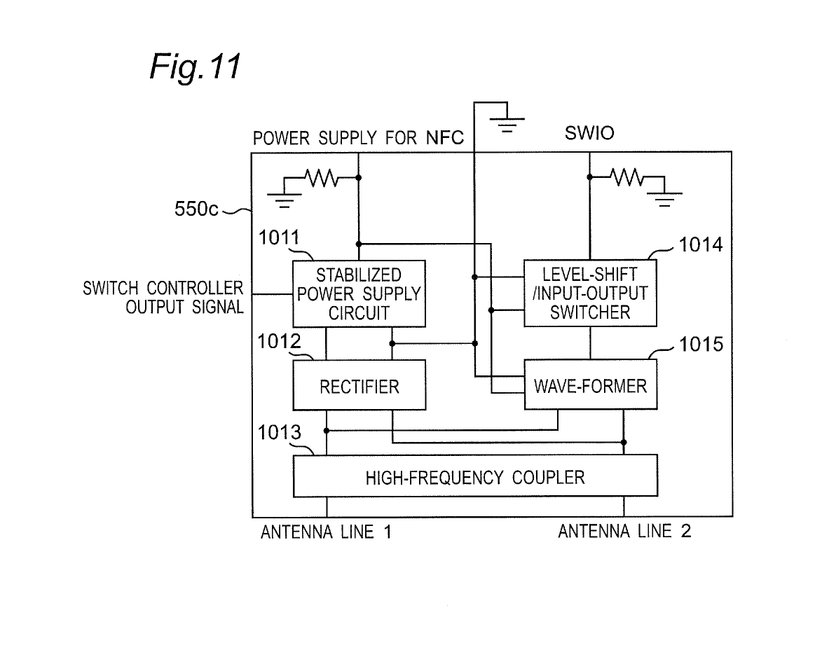

As shown in FIG. 10, the card communication device 4 according to the present embodiment does not have an antenna switching box. Instead, the card communication device 4 according to the present embodiment has an input/output converter 550c between the antenna contact pins 201, 202 and the loop antenna 600. FIG. 11 illustrates a concrete constitution example of the input/output converter 550c. The input/output converter 550c includes a stabilized power supply circuit 1011, a rectifier 1012, a high-frequency coupler 1013, a level-shift/input-output switcher 1014 and a wave-former 1015. These circuits are basically same as those explained in the second embodiment.

Especially, the stabilized power supply circuit 1011 according to the present embodiment is constituted so as to start/stop based on the output signal from the switch controller 400. By stopping the stabilized power supply circuit 1011, power supply to each of the circuits in the input/output converter 550c and the NFC microSD card 100 will stop. As a result, in the input/output converter 550c, the power supply for NFC and the generation of SWIO signals will stop, and furthermore, both of the signal line of the power supply for NFC and the signal line for SWIO signals are connected to the ground potential. As a result, the NFC microSD card 100 can be isolated of the loop antenna 600. That is to say, the input/output converter 550c has also a function as an antenna switching circuit.

As the examples of the technique disclosed in the present disclose, the first and second embodiments are described. However, the technique of the present disclose is not limited to them and can be applied also to embodiments that are suitably changed, replaced, added and omitted. Further, the components described in the first and second embodiments are combined so as to provide a new embodiment.

<Effects>

In the above embodiments, the card communication devices 1 and 2 include the loop antenna 600, the socket 200 for the NFC microSD card to which a memory card is attached, the memory card detecting mechanism 250 for detecting whether the memory card is attached to the socket 200 for the NFC microSD card, the switch controller 400 and the antenna switching box 500 for switching the electric connection of the terminal of the loop antenna 600 to the predetermined connecting terminal of the memory card attached to the socket 200 for the NFC microSD card between the on state and the off state, and the host LSI 300 for controlling the operations of the switch controller 400 and the antenna switching box 500.

When the memory card detecting mechanism 250 detects the attachment of the memory card to the socket 200 for the NFC microSD card, the host LSI 300 determines a type of the attached memory card. The host LSI 300 controls the switch controller 400 and the antenna switching box 500 so that the electric connection from the off state into the on state is switched only when the determined memory card is a specific type of the memory card. On the contrary, when the memory card detecting mechanism 250 detects the removal of the memory card from the socket 200 for the NFC microSD card, the host LSI 300 controls the switch controller 400 and the antenna switching box 500 so that the electric connection from the on state into the off state is switched.

The card communication device of the present disclose is compatible with memory cards having the antenna electrode terminals, and can normally operate memory cards mostly without causing a problem even if another kind of memory cards is attached. For example, the damage of the cards caused by the connection between the antenna and terminals other than the antenna electrode terminals can be avoided.

Further, in the embodiments, when the memory card detecting mechanism 250 detects the removal of a memory card from the socket 200 for the NFC microSD card, the host LSI 300 controls the switch controller 400 and the antenna switching box 500 so that the electric connection is brought into the off state.

As a result, when a memory card is attached to the socket 200 for the NFC microSD card next time, the electric connection between the terminal of the loop antenna 600 and the predetermined connecting terminal of the memory card to be attached is in the off state in advance. For this reason, the card damage due to the voltage applying at the time of attaching improper cards is not caused.

Further, in the embodiments, when the switch controller 400 and the antenna switching box 500 bring the electric connection into the off state, the connecting terminals of the memory card may be grounded. From the viewpoint of avoidance of the damage to the memory card, it is more effective to switch to the grounded state than only to bring the electric connection into the off state. This is because, when the electric connection is brought into the off state, a risk that the voltage of the line connected to the antenna contact pin might reach an expected value due to external induction-noises can be avoided.

As a result, since the connecting terminal of the memory card can be electrically protected, the card damage due to the voltage applying at the time of attaching improper cards is not caused.

In the embodiments, the socket 200 for the NFC microSD card has the antenna contact pins 201 and 202 for electrically connecting the loop antenna 600 and a memory card. The connecting terminals of the memory card contact with the antenna contact pins 201 and 202.

In the above embodiments, the specific type of memory card is a memory card compatible with wireless communication.

In the above embodiments, the specific type of memory card is an NFC-standardized memory card.

In the above embodiments, the specific type of memory card is an SD card. In this specification, the SD cards are ideas including cards of associated standards such as the SD card standards, and the microSD card standards.

In the above embodiments, the switch controller 400 has a flip flop that accepts the set signal and the reset signal from the host LSI 300. As a result, since the flip flop retains any one of the set state and the reset state, accordingly the on state or the off state of the electric connection can be maintained.

Further, in the embodiments, when the main power supply of the card communication devices 1 and 2 is in the off state, the standby power supply 720 may be provided as the standby power supply for supplying a power to the memory card detecting mechanism 250, the switch controller 400, the antenna switching box 500, and the host LSI 300.

As a result, even when the main power supply of the card communication devices 1 and 2 are brought into the off state, the electric connection can be switched according to the attachment and removal of memory cards. For example, the main power supply of the card communication devices 1 and 2 are in the off state, the NFC microSD card 100 attached to the socket 200 for the NFC microSD card is connected to the loop antenna 600, and the wireless communication between the NFC microSD card 100 and the external devices can be realized.

Even when the main power supplies of the card communication devices 1 and 2 are brought into the off state, the electric connection can be switched according to the attachment and the removal of memory cards. For example, the main power supplies of the card communication devices 1 and 2 are in the off state, the NFC microSD card 100 attached to the socket 200 for the NFC microSD card is connected to the loop antenna 600, so that the wireless communication between the NFC microSD card 100 and the external devices can be realized.

The card communication devices 1 and 2 are installed into electronic devices, such as personal computers, digital cameras, digital video cameras and card adapters, and communicate with external devices via readers, writers etc. thereof. By communicating with these external devices, the card communication devices 1 and 2, for example, update billing information, ticket information, point information etc., obtain specific information of each of external devices and exchange image data and audio data. Concretely, the card communication devices 1 and 2 write various data received from external devices into the NFC microSD card 100, and send out various data stored in the NFC microSD card 100.

That is to say, the card communication devices 1 and 2 are used as peripheral devices for personal computers, digital cameras, digital video cameras and card adapters to exchange various data with the external devices via the microSD card 100.

As the example of the technique of the present disclose, the embodiments are described. For this reason, the attached diagrams and the detailed description are provided.

Therefore, the components described in the accompanying drawings and the detailed description include not only the components essential for solving the problem but also the components that are not essential for solving the problem in order to exemplify the above technique. For this reason, even when these unessential components are drawn in the accompanying drawings and described in the detailed description, the unessential components should not be immediately regarded as essential components.

Further, since the above embodiments illustrate the technique of the present disclose, various modifications, replacements, additions and omissions can be carried out within the scope of claims and its equal scope.

Industrial Applicability

The present disclose can be applied to the card communication devices in which wireless communication memory cards for wirelessly communicating with external devices are attached to the card sockets.

What is claimed is:

1. A card communication device, comprising:
an antenna;
a card socket to which a memory card is attached;
a detector for detecting whether the memory card is attached to the card socket or not;
a switching section for switching electrical connection of a terminal of the antenna to a predetermined connecting terminal of the memory card attached to the card socket between an on state and an off state; and
a controller for controlling an operation of the switching section,
wherein when the detector detects the attachment of the memory card to the card socket, the controller determines a type of the attached memory card, and only when the determined memory card is a specific type of the memory card, the controller controls the switching section so that the electric connection is switched from the off state into the on state.

2. The card communication device according to claim 1, wherein when the detector detects removal of the memory card from the card socket, the controller controls the switching section so that the electric connection is brought into the off state.

3. The card communication device according to claim 1, wherein when the electric connection is brought into the off state, the switching section grounds the connecting terminal of the memory card.

4. The card communication device according to claim 1, wherein the card socket includes an antenna contact pin for electrically connecting the antenna with the memory card,
the connecting terminal of the memory card contacts with the antenna contact pin.

5. The card communication device according to claim 1, wherein the specific type of the memory card is a memory card compatible with wireless communication.

6. The card communication device according to claim 1, wherein the specific type of the memory card is an NFC-standardized memory card.

7. The card communication device according to claim 6, wherein the specific type of the memory card is an SD card.

8. The card communication device according to claim 1, wherein the switching section includes a flip flop for accepting a set signal and a reset signal from the controller.

9. The card communication device according to claim 1, further comprising a standby power supply for supplying a power to the detector, the switching section and the controller when the main power supply of the card communication device is in the off state.
